(19) United States
(12) Patent Application Publication
(10) Pub. No.: US 2014/0170974 A1
(43) Pub. Date: Jun. 19, 2014

(54) ELECTRONIC DEVICE AND METHOD FOR ESTABLISHING COMMUNICATION

(71) Applicant: HON HAI PRECISION INDUSTRY CO., LTD., New Taipei (TW)

(72) Inventor: TIEN-YU LIN, New Taipei (TW)

(73) Assignee: HON HAI PRECISION INDUSTRY CO., LTD., New Taipei (TW)

(21) Appl. No.: 14/051,508

(22) Filed: Oct. 11, 2013

(30) Foreign Application Priority Data
Dec. 13, 2012 (TW) 101147134

(51) Int. Cl. H04W 76/02

(52) U.S. Cl. CPC H04W 76/023
USPC 455/41.1; 455/41.2

(57) ABSTRACT

An electronic device capable of communicating with another electronic device in multiple wireless manners is provided. The first wireless manner enables the electronic device to automatically establish a first communication link with the another electronic device when the distance between the electronic device and the another electronic device is less than the predetermined value. The first wireless manner is used to set up a second communication link between electronic devices by simply moving one of the electronic devices toward the other, to open a connection to exchange parameters for establishing the second communication link, thereby the second communication link can be established as a second step without any user involvement. A method for establishing communication between electronic devices is also provided.

### BACKGROUND

1. Technical Field

The present disclosure relates to relate to Wireless Fidelity (WIFI) and Near Field Communication (NFC) technologies, and more particular to, a method for establishing communication between electronic devices having WIFI and NFC function.

2. Description of Related Art

With the popularity of handheld devices, such as mobile phones, a wireless communication between the handheld devices, or between the handheld devices and other devices (for example, televisions), is established to allow data to be transmitted. However, when a wireless communication between the handheld devices and other devices is to be established, users have to manually set configurations for establishing the wireless communication, which sometimes can be troublesome.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device system in accordance with an embodiment.

FIG. 2 is a flowchart of a method for establishing communication between a television and a handheld device in accordance with an embodiment.

FIG. 3 is a flowchart of a method for transiting data between the television and the handheld device after the communication between the television and the handheld device was established.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

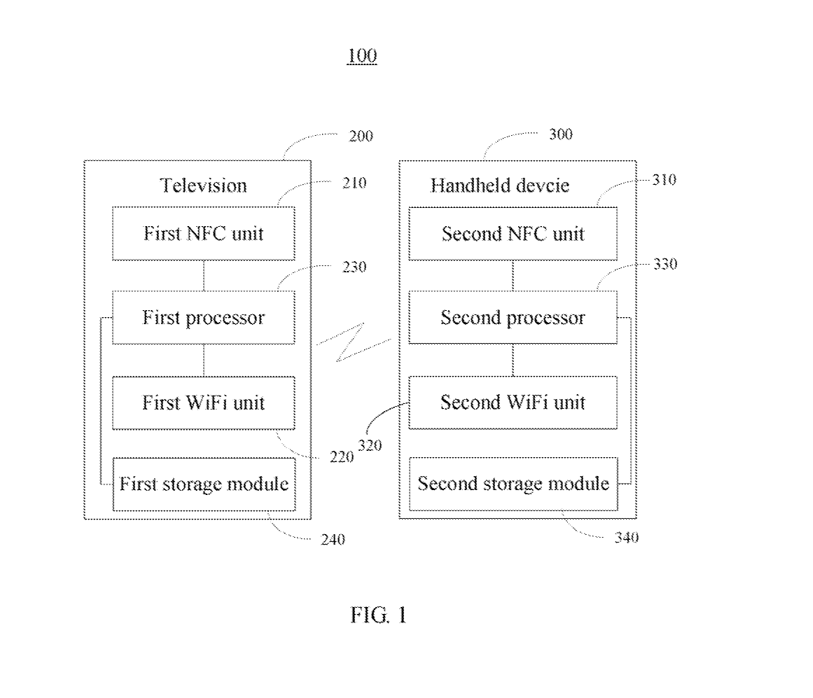

FIG. 1 shows an electronic device system 100 in accordance with an embodiment. The electronic device system 100 includes at least two electronic devices capable of communicating with each other in a first wireless manner and a second wireless manner different from the first wireless manner. Each electronic device includes a first communicating unit and a second communicating unit. The first communicating units automatically establish a first communication link between the electronic devices in the first wireless manner when the distance between the electronic devices is less than a predetermined value, and the second communicating units can establish a second communication link between the electronic devices in the second wireless manner. The first wireless manner in the embodiment in near field communication (NFC), which allows the electronic device to automatically communicate with each other when the distance between the electronic devices is less than a predetermined value, for example, 10 cm. The second wireless manner is different from the NFC, which allows the electronic devices to communicate with each other when the distance between the electronic devices is greater than the predetermined value. The second wireless manner may be WIFI, or BLUETOOTH, for example. In the embodiment, the second wireless manner is WIFI.

The NFC allows the electronic devices to automatically communicate with each other while the distance between the electronic devices is less than the predetermined value, NFC is used to set up a WIFI communication link between electronic devices by simply moving one of the electronic devices toward the other, to open a connection to exchange the parameters for establishing the WIFI communication. As a result, the WIFI communication link may be established as a second step without any user involvement. The same procedure may be used to establish a BLUETOOTH communicating link, for example, between two computers or consumer electronics devices like TVs, laptop computers, PDAs, mobile phones, and/or smart phones.

In operation, to achieve communication between the electronic devices, first, the electronic devices are moved toward each other, such that the distance between the electronic devices is less than the predetermined value. At this time, the electronic devices automatically establishes a NFC communication, to allow the electronic devices to intercommunicate with each other to exchange the parameters for establishing the WIFI communication. Then, one of the electronic devices (hereinafter, the requesting device) sends a request signal to the other electronic device (hereinafter, the requested device) for establishing the WIFI communicating, via the NFC communication that is established previously. The requested device receives the request signal and sends an authenticating signal to authenticate the requesting device. The requesting device responds to the authenticating signal by obtaining authenticating information thereof to perform authentication. The authenticating information is pre-stored in the electronic devices. The authenticating information can be a barcode, a manufacturer serial number, a combination of the barcode and the manufacture serial number, for example. Finally, the requested device establishes communication with the requesting device if the requesting device is authenticated. As a result, the WIFI communication is established without any user involvement.

The electronic device system 100 in the embodiment includes a television 200 and a handheld device 300. Both the television 200 and the handheld device 200 have NFC and WIFI function. The television 200 includes a first NFC unit 210 (the first communicating unit of the television 200) for receiving and/or transmitting NFC data, a first WIFI unit 220 (the second communicating unit of the television 200) for receiving WIFI data, and a first processor 230. The first NFC unit 210 and the first WIFI unit 220 may be integrated into a signal module or circuit. The handheld device 300 can be mobile phone, PDA, portable DVD player, or the like. The handheld includes a second NFC unit 310 (the first communicating unit of the handheld device 300), a second WIFI unit 320 (the second communicating unit of the handheld device 200) capable of intercommunicating with the first WIFI unit 220, and a second processor 330. The second NFC unit 310 and the second WIFI unit 320 may be integrated into a signal module or circuit. Both the first processor 230 of the television 200 and the second processor 330 of the handheld device 300 may enable processing of NFC data and processing of WIFI data. Furthermore, both the television 200 and the handheld device 300 includes a storage module (hereinafter a first storage module 240 and a second storage 340) for storing authenticating information, to provide authentication when one communicates with another electronic device by WIFI. In the embodiment, both the television 200 and the handheld device 300 provides NFC label for recording authenticating information, wherein the NFC labels are integrated into the first and second NFC units 210, 310. Because the NFC label is capable of reading and rewriting, users can edit the authenticating information to enhance safety.

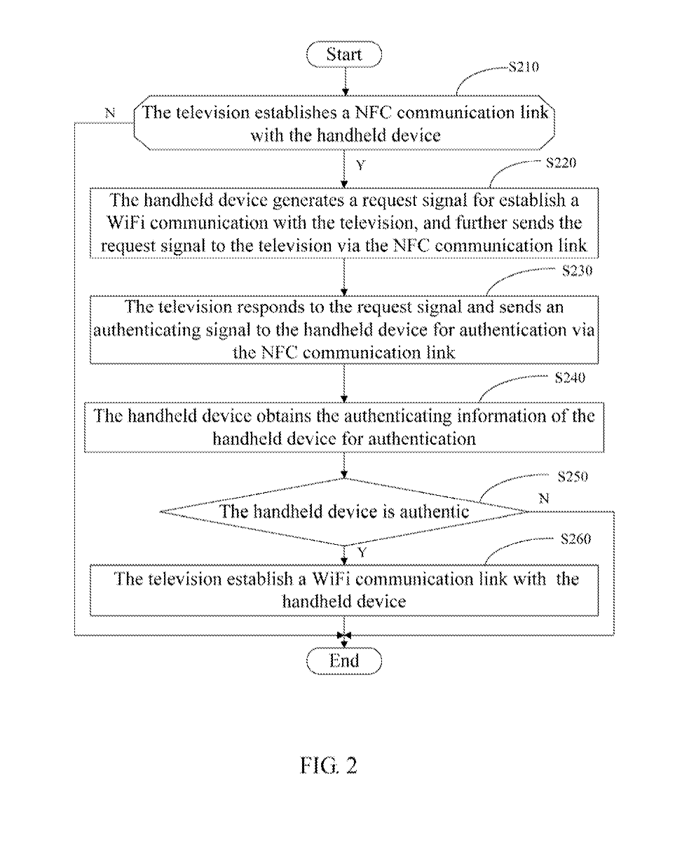

FIG. 2 is a flowchart illustrating one embodiment of a method for establishing communication between a handheld device and a television. The handheld device 300 (the requesting device) requests to establish a WIFI communication with the television 200 (the requested device).

In step S210, the second processor 330 of the handheld device 300 detects whether the second NFC unit 310 establishes a NFC communication link with the first NFC unit 210. If the second NFC unit 310 establishes the NFC communication link with the first NFC unit 210, the procedure goes to step S220. If the second NFC unit 310 does not establish the NFC communication link with the first NFC unit 210, the procedure ends. In the embodiment, the request device (the handheld device 300) provides a special key/button (not shown) for activating the second processor 330 to detect whether the second NFC unit 310 establishes a NFC communication link with the first NFC unit 210.

In step S220, the second processor 330 of the handheld device 300 generates a request signal for establish the WIFI communication with the television 200. In addition, the second processor 330 further sends the request signal to the television 200, via the NFC communication link that was established previously between the first and second NFC units 210, 310.

In step S230, the first processor 230 of the television 200 responds to the requesting signal from the handheld device 300 and sends an authenticating signal to the handheld device 300 for authentication, via the NFC communication link.

In step S240, the second processor 330 obtains the authenticating information of the handheld device 300 for authentication.

In step S250, the first processor 230 determines if the authenticating information obtained by the second processor 330 is authentic. When the authenticating information obtained by the second processor 330 is authentic, the procedure goes to step S260. When the authenticating information obtained by the second processor 330 is not authentic, the procedure ends.

In step S260, the first processor 330 controls the first WIFI unit 220 to establish WIFI communication with the second WIFI unit 320. Thus, by moving the handheld device 300 toward the television 200, a WIFI communication link between the television 200 and the handheld device 300 can be set up, without any user involvement.

When the television 200 as the requesting device requests to establish a WIFI communication link with the handheld device 300 as the requested device, the principle of the television 200 acts as the requesting device for establishing the WIFI communication link between the television 200 and the handheld device 300 is similar to the principle of the handheld device 300 acts as the requesting device for establishing a WIFI communication link between the television 200 and the handheld device 300. In detail, a special key/button provided by the television 200 is depressed to actuated the first processor 230 to detect whether the first NFC unit 210 establishes the NFC communication with the second NFC unit 310. If the first NFC unit 210 establishes NFC communication with the second NFC unit 310, the first processor 230 generates a request signal for establish a WIFI communication link with the handheld device 300. In addition, the first processor 230 further sends the request signal to the handheld device 300, via the NFC communication link that was established previously between the first and second NFC units 210, 220. The second processor 330 responds to the request signal from the television 200 and sends an authenticating signal to the television 200 for authentication, via the NFC communication link. The first processor 230 obtains the authenticating information of the television 200 for authentication. The second processor 330 determines whether the authenticating information obtained by the first processor 230 is authenticated. When the authenticating information obtained by the first processor 230 is authenticated, the second processor 330 controls the second WIFI unit 320 to establish a WIFI communication link with the first WIFI unit 220.

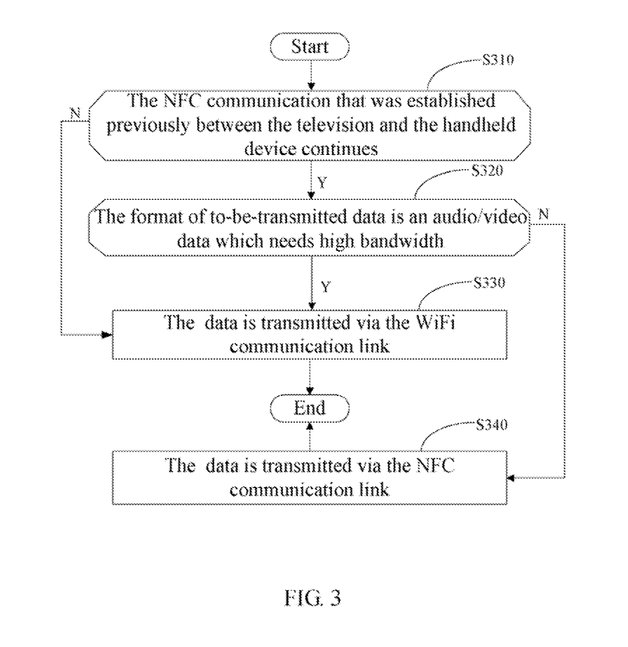

The NFC is a low speed communication protocol, with high safety, in contrast, the WIFI is a high speed communication protocol, with relatively low safety, thus, when the to-be-transmitted data request lower bandwidth, the to-be-transmitted data is preferred to be transmitted via the NFC communication link, to enhance safety. FIG. 3 illustrates a method for transmitting data between electronic devices after the WIFI communication link was established.

In step S310, the processor of the requesting device (for example, the second processor 330 of the handheld device 300) determines that if the NFC communication that was established previously between the television 200 and the handheld device 300 continues, in other words, the distance between the television 200 and the handheld device 300 is less than the predetermined value. If yes, the procedure goes to step S320. If not, the procedure goes to step S330.

In step S320, the second processer 330 determines whether the format of to-be-transmitted data is an audio/video data which needs high bandwidth. If yes, the procedure goes to step S330. If not, the procedure goes to step S340.

In step S330, the to-be-transmitted data is transmitted via the WIFI communication link. When the data is fully transmitted via the WIFI communication link, the procedure ends.

In step S340, the to-be-transmitted data is transmitted via the NFC communication link, to enhance safety of the data. When the data is fully transmitted via the NFC communication, the procedure ends.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of communicating with another electronic device, the electronic device comprising:
a first communicating unit automatically establishing a first communication link with the another electronic device in a first wireless manner when the distance between the electronic device and the another electronic device is less than a predetermined value;
a second communicating unit allowing the electronic device to establish a second communication link with the another electronic device in a second wireless manner; and
a processor for detecting whether the electronic device establishes the first communication link with the another electronic device in the first manner, and sending a request signal to the another electronic device for establishing a second communication link via the established first communication link, and further performing authentication in response to an authenticating signal from the another electronic device, and controlling the second communicating unit to establish the second communication link with the another electronic device in the second manner when the electronic device is authenticated.

2. The electronic device of claim 1, wherein the first wireless manner is Near Field Communication (NFC).

3. The electronic device of claim 2, wherein the first communicating unit is a NFC unit for communicating with the another electronic device when the distance between the electronic device and the another electronic device is less than the predetermined value.

4. The electronic device of claim 3, wherein the electronic device provides a NFC label integrated into the NFC unit, the NFC label records the authenticating information of the electronic device for authenticating when the electronic device establishes the second communication link with the another electronic device.

5. The electronic device of claim 4, wherein the authenticating information is one selected from a group of a barcode, a manufacturer serial number, and the combination of the barcode and the manufacturer serial number.

6. The electronic device of claim 2, wherein the second wireless manner is one selected from a group of WIFI and BLUETOOTH.

7. A method for establishing communication between an electronic device and another electronic device, the electronic device capable of automatically establishing a first communication link with the another electronic device in a first wireless manner when the distance between the electronic device and the another electronic device is less than a predetermined value, and capable establish a second communication link with the another electronic device in a second wireless manner, the method comprising:
detecting whether the electronic device establishes the first communication link with the another electronic device;
sending a request signal to the another electronic device for establishing the second communication link via the established first communication link;
performing authentication in response to an authenticating signal from the another electronic device; and
controlling the first communicating device to establish the second communication link with the another electronic device when the electronic device is authenticated.

8. The method of claim 7, wherein the first wireless manner is Near Field Communication (NFC).

9. The method of claim 8, wherein the electronic device comprises a NFC unit for communicating with the another electronic device when the distance between the electronic device and the another electronic device is less than the predetermined value.

10. The method of claim 9, further comprising:
providing a NFC label integrated into the NFC unit, wherein the NFC label records the authenticating information of the electronic device for authenticating when the electronic device establishes the second communication link with the another electronic device.

11. The method of claim 10, wherein the authenticating information is one selected from a group of a barcode, a manufacturer serial number, and the combination of the barcode and the manufacturer serial number.

12. The method of claim 8, wherein the second wireless manner is one selected from a group of WIFI and BLUETOOTH.
